(19) United States
(12) Patent Application Publication
(10) Pub. No.: US 2010/0319255 A1
(43) Pub. Date: Dec. 23, 2010

(54) PROCESS AND SYSTEM FOR PRODUCTION OF SYNTHESIS GAS

(76) Inventors: Douglas Struble, Maumee, OH (US); Noureen Faizee, Toledo, OH (US); Max Hoetzl, Maumee, OH (US)

Correspondence Address: TUROCY & WATSON, LLP, 127 Public Square, 57th Floor, Key Tower, CLEVELAND, OH, 44114, US

(21) Appl. No.: 12/817,033

(22) Filed: Jun. 16, 2010

Related U.S. Application Data
(60) Provisional application No. 61/218,197, filed on Jun. 18, 2009.

(51) Int. Cl. C01B 3/02; C10J 3/48

(52) U.S. Cl. 48/62 R; 48/197 R

(57) ABSTRACT

System(s) and process(es) are provided to produce synthesis gas from feedstock through, in part, multi-phased gasification and steam reformation. In the multi-phased gasification, an amount of feedstock is supplied to a pyrolysis chamber in which high-pressure pyrolysis at a first temperature reforms into gas at least a portion of the amount of feedstock; the gas includes synthesis gas (syngas). An amount of feedstock by-product that results from the high-pressure pyrolysis is conveyed to a solids reactor functionally coupled to the pyrolysis chamber. At least a portion of the amount of feedstock by-product is reformed into syngas at high-pressure and a second temperature within the solids reactor; an amount of disposable solids is ejected from the solids reactor. Gas produced in the pyrolysis chamber or syngas produced in the solids reactor is saturated via steam reformation and cleaned. Clean syngas is supplied for fuel production.

### CROSS-REFERENCE TO RELATED APPLICATION

This application claims the benefit of U.S. Provisional Patent Application Ser. No. 61/218,197, entitled “Rotatory Retort Pyrolyzer System” and filed on Jun. 18, 2009. The entirety of the above-noted US Provisional Patent Application is incorporated herein by reference.

### TECHNICAL FIELD

The subject disclosure relates to production of bio-fuel from feedstock and, more specifically, to generation of synthesis gas based in part on multi-phased gasification and steam reformation, wherein the multi-phased gasification can be enabled through a secondary solids reactor.

### BACKGROUND

A convergence of various financial factors, such as increase in fossil fuel costs; market forces (e.g., adherence to sustainable energy consumption paradigms); and geopolitical conditions (instability in oil-rich regions, climate change, etc.) has renewed interest in gasification of organic or carbonaceous materials, often called feedstock, to generate combustible synthesis gas (or syngas) for renewable generation of fuel. Synthesis gas can be utilized to generate electricity with reduced CO₂ emissions compared to electricity derived from fossil fuel. In addition, feedstock utilized for generation of synthesis gas is largely encompassed by post-processed (organically or synthetically) waste; therefore, feedstock is intrinsically sustainable. Amongst various gasification processes commonly employed for generation of synthesis gas is pyrolysis. Such process produces by-products, such as chars or tars, in addition to production of synthesis gas. In conventional gasification systems, the feedstock is dried and supplied into a stirred, heated kiln. As the feedstock passes through the kiln, combustible synthesis gas is produced and is continuously removed from the kiln. However, production of synthesis gas in conventional gasification systems is generally inefficient, with an energy balance that renders production of fuel or electricity derived thereof commercially non-viable. In addition, conventional processes generally exacerbate commercial viability issues with elevated operational costs associated with process inefficiencies related to manipulation of produced by-products. In addition, poorly designed management of the by-products also result in synthesis gas of lesser quality, with ensuing low quality of derived fuels and ensuing limited commercial thereof.

### SUMMARY

The following presents a simplified summary of the subject disclosure in order to provide a basic understanding of some aspects thereof. This summary is not an extensive overview of the various embodiments of the subject disclosure. It is intended to neither identify key or critical elements nor delineate any scope. Its sole purpose is to present some concepts in a simplified form as a prelude to the more detailed description that is presented later.

One or more embodiments provide system(s) and process(es) to produce synthesis gas from feedstock through multi-phased gasification and steam reformation. In the multi-phased gasification, an amount of feedstock material is supplied to a pyrolysis chamber in which high-pressure pyrolysis at a first temperature decomposes (e.g. devolatizes) into pyrolysis gas at least a portion of the amount of feedstock material; the pyrolysis gas includes synthesis gas and other gases comprising heavier molecules. High pressure can increase efficiency of the pyrolysis phase. An amount of feedstock by-product that results from the high-pressure pyrolysis is conveyed to a solids reactor which is functionally coupled to the pyrolysis chamber so as to maintain a high-pressure environment. At least a portion of the amount of feedstock by-product is reformed into syngas at high-pressure and at a second temperature within the solids reactor; an amount of disposable solids is ejected from the solids reactor. Gas produced in the pyrolysis chamber is reacted in a steam reformation reactor, syngas produced in the solids reactor also can be saturated via steam reformation in the steam reformation reactor. Syngas produced from steam reformation of pyrolysis gas and reacted syngas are cleaned in a scrubbing apparatus. In certain embodiments, one or more cyclones also can be employed to clean the pyrolysis gas. Clean syngas is supplied for fuel production or for chemical production.

When compared to conventional processes for synthesis gas production, implementation of a primary gasification phase and a secondary gasification phase has at least the following three advantages. (i) Increased efficiency of thermal management in a steam reformation phase, with ensuing increased efficiency (reduced operational costs, higher yield, etc.) of synthesis gas production. (ii) Increased durability of equipment employed to implement the steam reformation phase due in part to reduced amount of abrasive material injected in the equipment. (iii) At a time of achieving a production of clean synthesis gas or after a time interval thereafter, the multi-phased gasification process disclosed herein can be effected in an energy self-sustained mode.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram that illustrates a multi-phased gasification process for production of synthesis gas in accordance with aspects of the subject disclosure.

FIG. 2 is a block diagram of an example multi-phased gasification system that enables and exploits various aspects of the subject disclosure.

FIGS. 3A-3B present block diagrams of an example embodiment of a pyrolyzer chamber in accordance with aspects described herein.

FIGS. 4A-4B present block diagrams of an example embodiment of a solids reactor in accordance with aspects described herein.

FIG. 5 illustrates a block diagram of an example gasification system with components for steam production in accordance with aspects described herein.

FIG. 6 presents a block diagram of an example multi-phased gasification system in accordance with aspects described herein.

FIGS. 7-8 are flowcharts of example methods for producing synthesis gas in accordance with aspects of the subject disclosure.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the present disclosure. It may be evident, however, that the various embodiments of the subject disclosure may be practiced without these specific details. In other instances, well-known structures and devices are shown in block diagram form in order to facilitate describing the present disclosure.

As employed in this specification and annexed drawings, the terms “component,” “system,” “structure,” “platform,” “interface,” and the like are intended to include a computer-related entity or an entity related to an operational apparatus with one or more specific functionalities, wherein the entity can be either hardware, a combination of hardware and software, software, or software in execution. One or more of such entities are also referred to as “functional elements.” As an example, a component may be, but is not limited to being a process running on a processor, a processor, an object, an executable, a thread of execution, a program, and/or a computer. As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. An illustration of such a component can be a water pump. In addition or in the alternative, a component can provide specific functionality based on physical structure or specific arrangement of hardware elements; an illustration of such a component can be a filter or a fluid tank. As yet another example, a component can be an apparatus that provides specific functionality through electronic components without mechanical parts, the electronic components can include a processor therein to execute software or firmware that provides at least in part the functionality of the electronic components. An illustration of such apparatus can be control circuitry, such as a programmable logic controller. The foregoing example and related illustrations are but a few examples and are not intended to limiting. Moreover, while such illustrations are conveyed for a component, the examples also apply to a system, a structure, a platform, an interface, and the like.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of synthesis gas collection structures includes one or more synthesis gas collection structures; a set of devices includes one or more devices; a set of regulators includes one or more regulators; etc.

Various aspects or features will be presented in terms of systems that may include a number of devices, components, modules, and the like. It is to be understood and appreciated that the various systems may include additional devices, components, modules, etc., or may not include all of the devices, components, modules etc. discussed in connection with the figures. A combination of these approaches also can be used.

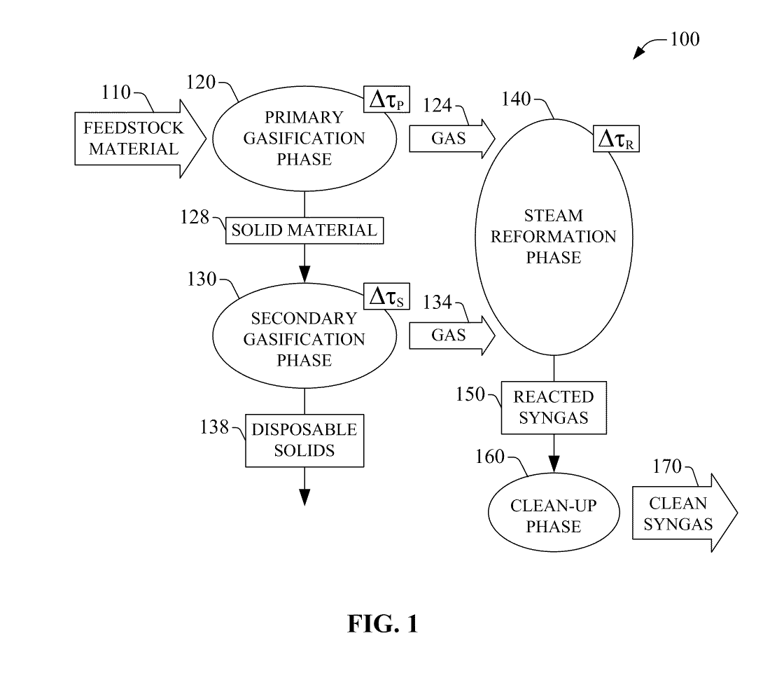

FIG. 1 is a diagram that illustrates an example multi-phased gasification process 100 for production of synthesis gas in accordance with aspects of the subject disclosure. To produce synthesis gas, feedstock material 110 is introduced into a primary gasification phase 120 which can be a non-combustion gasification phase. In one or more embodiments, the primary gasification phase 120 is a pyrolysis phase. Various types of feedstock material can be employed, such as biomass (wood, rice, corn, or sugar cane harvest waste, etc.), municipal waste (moist or dry), farm compost, coal, petroleum coke, and the like.

Pressure (P_{P}) and temperature (T_{P}) of the primary gasification phase 120 are regulated. In addition, decomposition and gasification of the feedstock material is effected for a predetermined period Δτ_{P}. Specific values of pressure P_{P}, temperature T_{P}, and Δτ_{P} can be determined through simulation or experimentation. In one or more embodiments, P_{P} ranges from about 25 psi to 100 psi; T_{P} ranges from nearly 1000° F. to nearly 1750° F.; and 10 min≦Δτ_{P}≦36 min, where “min” is the abbreviation of the term minutes; in an embodiment Δτ_{P} is equal to about 36 min and in another embodiment Δτ_{P} is equal to about 10 min. Values of P_{P} elevated with respect to atmospheric pressure allow high efficiency, e.g., high gas yield, of the primary gasification phase 120. Primary gasification phase 120 results in gas stream 124, also referred to as gas 124 and solid material 128, which is conveyed to a secondary gasification phase 130; the gas stream 124 can be a volume of gas or a flow of gas. If the primary gasification phase 120 is a pyrolysis phase, which can be conducted in one or more pyrolysis chambers, the gas stream 124 is pyrolysis gas which includes synthesis gas (syngas) and other gases comprising heavier molecules. Synthesis gas that is part of pyrolysis gas can have a H₂-to-CO that is non-ideal for fuel production. Solid material 128 can be by-product condensed matter that is produced in primary gasification phase 120; e.g., solid material 128 can include incompletely pyrolyzed feedstock material, such as char, bio-char, or the like.

The secondary gasification phase 130 also is a non-combustion gasification phase effected at a predetermined pressure (P_{S}) and at a temperature (T_{S}) during a specific period Δτ_{S}. In certain embodiments, for example, the non-combustion gasification phase may be a pyrolysis phase. The products of the secondary gasification phase 130 are gas stream 134, also referred to as gas 134, and disposable solids 138; the gas stream 134 can be a volume of gas or a flow of gas. In an aspect, the gas in the gas stream 134 can be substantially synthesis gas (syngas). A disposal structure (not shown in FIG. 1) that maintains at least pressure conditions is utilized to discard the disposable solids 138. Similarly to the primary gasification phase 120, values of pressure, temperature, and Δτ_{S} of the secondary gasification phase 130 can be determined through simulation or experimentation. In one or more embodiments, P_{S} ranges from about 25 psi to about 100 psi—lower or higher values also can be employed—; T_{S} ranges from about 1000° F. to about 1750° F.; and 3 min≦Δτ_{S}≦20 min, where “min” is the abbreviation of the term minutes; in an embodiment Δτ_{S} is equal to about 20 min and in another embodiment Δτ_{S} is equal to about 3 min.

In an aspect of the subject disclosure, values of the set of parameters {P_{P},T_{P};Δτ_{P}} and {P_{S},T_{S};Δτ_{S}} can be based at least on one or more of (i) intended operation condition(s), such as amount of input feedstock material 110, type of feedstock material 110, moisture level of feedstock material 110, particle size of feedstock material 110, or likely or expected types of by-product produced through gasification of feedstock material 110; intended synthesis gas yield; (ii) budgetary or other financial considerations; (iii) delivery and installation costs of equipment to perform the primary gasification phase 120; or the like. In certain embodiments, determination of such set of parameters can be effected autonomously, e.g., via an assessment platform (not shown), in order to attain specific output performance, such as syngas quality, syngas yield, specific loading rate(s) of feedstock material, operational costs, or the like.

As a result of primary gasification phase 120 and secondary gasification phase 130, a first volume of gas 124 (e.g., pyrolysis gas) and a second volume of gas 134 (e.g., syngas) are supplied to a steam reformation phase 140, in which the first volume of gas (e.g., pyrolysis gas) and second volume of gas (e.g., syngas) are reacted with steam (e.g., superheated steam) to produce consistent raw syngas, wherein the consistent raw syngas can be saturated syngas, e.g., syngas with nearly the highest H₂/CO ratio. In one or more embodiments, based on quality (H₂/CO ratio, concentration of impurities, etc.) gas 134 (e.g., syngas) produced in secondary gasification phase 130 can be supplied to clean-up phase 160 instead of steam reformation phase 140. In an aspect, a quality assessment phase (not shown in FIG. 1) can be implemented prior to conveying gas 134 (e.g., syngas). Reaction of produced syngas with steam is sustained for a period Δτ_{R}, which in certain embodiments can satisfy Δτ_{R}≦10 seconds (s), or Δτ_{R} equal to about 10 s; e.g., 3 s≦Δτ_{R}≦5 s. The product of the steam reformation phase 140 is reacted syngas 150, which can be supplied to clean-up phase 160, to yield a volume of clean syngas 170 that is saturated. It should be appreciated that in contrast to conventional systems of feedstock, the example multi-phase gasification process 100 disclosed herein avoids recycling incompletely decomposed feedstock material (e.g., solid material 128) from steam reformation phase 140, and structure(s) that enables such steam reformation phase, back to primary gasification phase 120 or to any or most any phase or portion of the example multi-phase gasification process 100.

At least one advantage of multi-phase gasification process 100 is that efficiency of steam reformation phase 140 is increased with respect to conventional gasification systems that exploit a single gasification phase because hot gases (e.g., gas 124 and gas 134) are allowed in the steam reformation phase 140, and structure that enables such steam reformation phase, while ash and partially decomposed feedstock are directed to secondary gasification phase 130. Addition of such ash and decomposed feedstock in the steam reformation phase 140, and structure that enables such reformation phase, generally consumes heat and thus excess heat can be required to maintain temperature level of steam reformation phase 140. In addition, at least another advantage of multi-phase gasification process 100 is that throughput of steam reformation phase 140, for example, reacted syngas 150, is increased with respect to conventional gasification systems since non-reactive materials do not occupy space in the structure(s) (e.g., steam reformation reactor) that enable the steam reformation phase 140. Moreover, by redirecting solid material 128 to secondary gasification phase 130, durability, or life span, of structure(s) that enable steam reformation phase 140 is increased since injection of abrasive material into such structure(s) is reduced and thus premature wearing of the structure(s) is largely mitigated.

The clean syngas 170 can be produced through removal of particulate matter (pm), tars, and other contaminants (sulfur-based compounds, soluble acid gas(es), etc.) from the produced, reacted syngas 150. The clean-up phase 160 can include a set of cyclones through which raw gas is circulated. In addition, the clean-up phase 160 can include liquid-based refrigeration of the reacted syngas 150, which is saturated dirty syngas at elevated temperature, e.g., 1000° F. or substantially 1000° F. In certain embodiments, clean-up phase 160 does not include a cooling stage—for example, reacted syngas 150 is not circulated through an entrained heat-flow exchanger—and thus temperature of the reacted syngas 150 can range from about 1700° F. to 1750° F. In an aspect, the temperature of the reacted syngas 150 is reduced to about saturation temperature (for example, 237° F. under certain conditions) through ambient-temperature liquid coolant (e.g., water) that removes the particulate matter, the tars, and other contaminants from the reacted syngas 150. In additional or alternative aspects, the temperature of the reacted syngas 150 can be reduced to temperatures below the saturation temperature or to temperatures above the saturation temperature, but that are substantially lower than the temperature at which the reacted syngas 150 exits the steam reformation phase 140. In certain embodiments, the temperature of the reacted syngas 150 is lower than about 237° F., while in alternative or additional embodiments, the temperature of the reacted syngas 150 is higher than about 237° F.

Secondary gasification phase 130 increases the amount of feedstock material that is gasified and thus reduces the amount of or eliminates extraneous, abrasive solid matter that is conveyed to the steam reformation phase 140. Thus, when compared to conventional processes for synthesis gas production, implementation of the secondary gasification phase 130 has at least the following two advantages. (1) Increased efficiency of thermal management, e.g., heat exchange, temperature preservation, in the steam reformation phase 140, with ensuing increased efficiency (reduced operational costs, higher yield, etc.) of synthesis gas production. (2) Increased durability of equipment employed to implement the steam reformation phase 140 due in part to reduced amount of abrasive material injected in the equipment.

Additionally, at a time of achieving a production of clean syngas 170 or after a time interval thereafter, the multi-phased gasification process disclosed herein can be effected in an energy self-sustained mode. Utilization of produced clean syngas 170 to fuel the multi-phased gasification process described herein, leads to emissions that are low, similar to emissions that result when clean natural gas is utilized, for example. It should be appreciated that clean syngas produced through the multi-phased process described herein is carbon neutral. Utilization of clean syngas 170 also allows for consistent gas to be provided to the multi-phased gasification process. In contrast, with various conventional gasification processes the combustion of the feedstock provides process heat (process of combustion (POC) heat) which produces large amounts of contaminants and introduces process variation related to feedstock type, composition size, and moisture. In such mode, production of clean syngas 170 is effected at a predetermined rate with a specific product mix standard, e.g., a specific quality of clean syngas 170, and at least a portion of the clean syngas 170 fuels equipment that enables or implements at least one of primary gasification phase 120, secondary gasification phase 130, steam reformation phase 140, or clean-up phase 160. Such energy self-sustained mode of implementation of the multi-phased gasification process described herein is at least another advantage of the subject disclosure; self-sustained mode of implementation is generally not accomplished in conventional gasification systems.

It should be appreciated that, based on the content of fixed carbon (C) in the feedstock material 110, the secondary gasification phase 130 can be avoided and the solid material 128 can be discarded. In an aspect, low fixed C feedstock can result in solid material 128 with an elevated energy barrier for decomposition and gasification, and therefore production of gas 134 can be energy inefficient. In addition, in certain embodiments, primary gasification phase 120 or secondary gasification phase 130 can incorporate steam from an external source (not shown) to react gas that results from gasification and produce a larger concentration of synthetic gas (syngas) or a syngas with better composition.

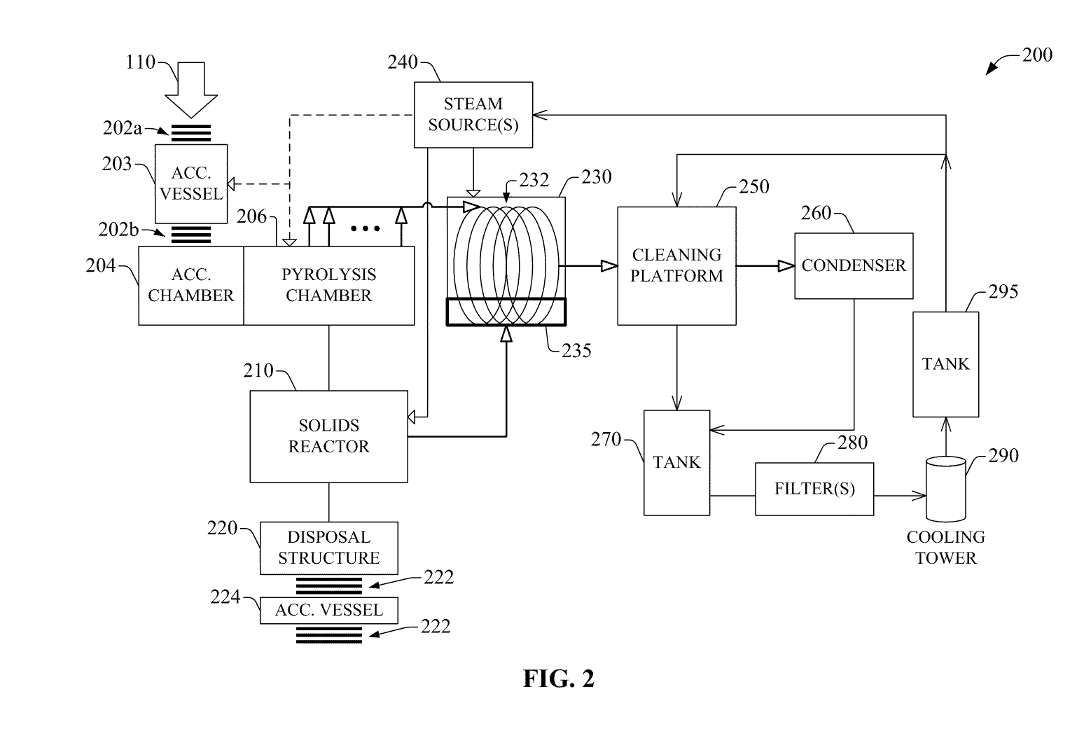

FIG. 2 is a block diagram of an example non-combustion gasification system 200 that enables and exploits various aspects of the subject disclosure. The subject example gasification system 200 can implement the multi-phased gasification process described hereinbefore in connection with FIG. 1. An amount (e.g., weight or volume) of feedstock material 110 is supplied through a set of air-lock valves 202a, an accumulation (acc.) vessel 203, and an accumulation chamber 204 into a pyrolysis chamber 206, which effects a primary gasification phase (e.g., 120) as described supra. While illustrated with a pyrolysis chamber, in one or more embodiments, any or most any suitable gasification chamber can be employed in example gasification system 200, wherein a suitable gasification chamber has the physical properties that enable a gasification phase (e.g., primary gasification phase 120) as described herein. The amount of feedstock material 110 can be metered prior to injection into the accumulation vessel 203 through the set of air-lock valves 202a (such set represented with thick line segments in FIG. 2); the feedstock material 110 can be injected at a feed rate that ranges from about 5 to about 500 dtpd (dry tons per day). The injection of the feedstock material 110 can be accomplished in part through a conveyor line (not shown) that delivers the feedstock material to a hopper (not shown) functionally coupled to the set of air-lock valves 202a. Feedstock material 110 can collect continually in the hopper (not shown).

To inject an amount of feedstock material 110 into accumulation vessel 203, at least one air-lock valve in the set of air-lock valves 202a is opened for a period of time suitable to inject the amount of feedstock material 110, while each air-lock valve in a set of air-lock valves 202b at the opposing end of accumulation vessel 203 remains closed. After injection of the amount of feedstock material 110 is complete, the at least one air-lock valve in the set of air-lock valves 202a is closed and the accumulation vessel 203 is pressurized to an operating pressure substantially the same as the pressure of primary gasification phase; e.g., pressure P_{P} in the range from about 25 psi to about 100 psi. It should be appreciated that the sets of air-lock valves 202a and 202b and the accumulation vessel 203 enable supply of the amount of feedstock material 110 at any or most any predetermined pressure higher than atmospheric pressure. After pressurization of accumulation vessel 203, at least one air-lock valve in the set of air-lock valves 202b is opened, which allows at least a portion of the amount of feedstock material 110 to be supplied to accumulation chamber 204 at the operating pressure (e.g., a pressure in the range from about 25 psi to nearly 100 psi). In addition, accumulation chamber 204 includes a structure, such as an auger or a plunger, that enables ejecting the amount of feedstock material 110 collected in the accumulation chamber 204 to the pyrolysis chamber 206. In an embodiment, the plunger can be embodied in a pneumatic cylinder functionally coupled (e.g., through a rigid bar and suitable attachment(s)) to a plate that can push at least a portion of the amount of feedstock material 110 into the pyrolysis chamber 206. Accumulation chamber 204 also includes at least one control valve (not shown) that holds positive pressure (e.g., a pressure from about 25 psi to about 100 psi) in example gasification system 200.

In an aspect of the subject disclosure, the two sets of air-lock valves 202a and 202b, and the accumulation vessel 203 allow air removal from collected feedstock material 110. The air removal mitigates (e.g., avoids) injection of air into the pyrolysis chamber 206 and can improve quality (H₂/CO ratio, concentration of impurities, etc.) of synthesis gas produced as part of generation of gas (e.g., pyrolysis gas) through the primary gasification phase (e.g., 120). In an aspect, as part of pressurization of accumulation vessel 203, operating pressure of example gasification system 200 flushes, or purges, air contained in the feedstock material 110 collected in the accumulation vessel 203. As indicated supra, the operating pressure can range from nearly 25 psi to nearly 100 psi.

Injection of the feedstock material 110 can be accomplished in batch mode. The set of air-lock valves 202b (such set represented with thick line segments in FIG. 2) functionally connected to accumulation chamber 204 can enable providing the amount of feedstock material 110 in such batch mode, with a predetermined batch cycle period or in continuous mode; a batch cycle period can range from about 1 minute to about 10 minutes. The amount of feedstock material 110 that is loaded in accumulation chamber 204 is dictated at least in part by a feed rate, e.g., a rate at which feedstock material 110 is supplied; it should be appreciated that feedstock material 110 is loaded when at least one air-lock valve in the set of air-lock valves 202b is open. In batch mode, loading of feedstock material 110 for a batch cycle is initiated through depressurization of accumulation vessel 203 to recover normal atmospheric condition from operating pressure (e.g., nearly 25 psi to nearly 100 psi) of example gasification system 200 in order to enable an amount of feedstock material to be collected in the accumulation vessel 203 from the hopper (not shown) and supplied to accumulation chamber 204, as described supra. It should be appreciated that depressurization of accumulation vessel 203 occurs with each air-lock valve in the set of air-lock valves 202a and each air-lock valve in the set of air-lock valves 202b is closed. In an embodiment, process gas relieved as part of the depressurization circulates through a baghouse (not shown), which enables removal of any or most any feedstock particulate matter that is present in the relieved process gas. In an aspect, relieved process gas cleansed through the baghouse (not shown) is supplied to a closed circuit of combustion air to be combusted as part of the multi-phase gasification process described herein. At least one advantage of the closed circuit for combustion air is that process gas is not released to the atmosphere with the ensuing environmental adequacy. Thus administrative procedures such as procurement of permit(s) for deployment of gasification systems described herein (e.g., 200 or 600) can be simplified.

In contrast to conventional gasification systems, in view of a steam reformation stage that is part of non-combustion gasification described herein, the feedstock material 110 injected into example gasification system 200 can contain moisture and thus it need not be dried prior to injection into the pyrolysis chamber 206. In particular, though not exclusively, in one or more embodiments, a volume of steam can be supplied to pyrolysis chamber 206. Injection of the volume of steam is optional—as represented by a dashed flat, short arrow that reaches the pyrolysis chamber 206—and allows control of the composition of produced synthesis gas during the various gasification phases conducted in example gasification system 200. In addition or in the alternative, steam can be injected in the accumulation vessel 203; injection of such steam also is optional. Injection of steam allows for production of synthesis gas with specific, predetermined chemical composition (e.g., ratio of H₂/CO); based at least on moisture of the feedstock material 110, an amount (e.g., a flow or a volume) of steam is regulated to achieve a specific, desired ratio of steam to carbon for a desired syngas composition. Moreover, in additional or alternative embodiments, injection of feedstock material 110 into pyrolysis chamber 206 can include addition of water into the feedstock material; water can be injected in a specific water-to-solid ratio ρ (a real number). As an example, ρ can range from about 1 to about 1.5.

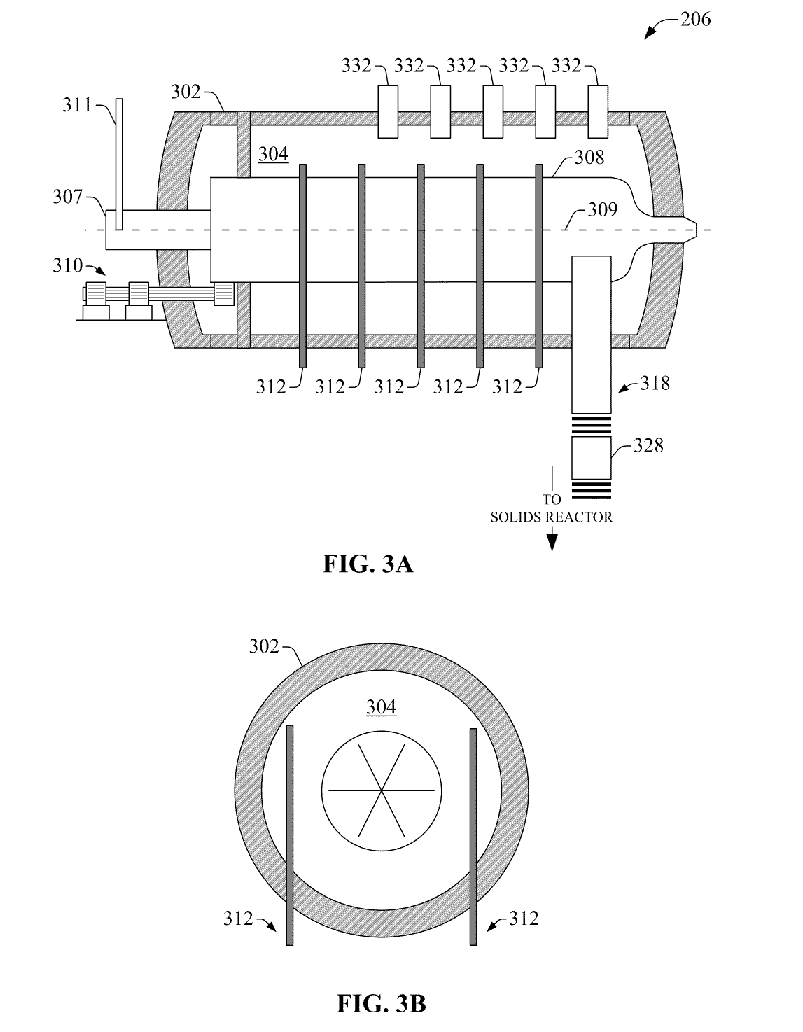

In one or more embodiments, such as the example embodiment illustrated in FIGS. 3A-3B, the pyrolysis chamber 206 is a vessel 302, with an inner surface coated, or lined, with a refractory material that can retain heat for the gasification of feedstock material; the refractory material is represented with right-slanted dashed area in FIGS. 3A-3B. The vessel 302 is a source of the heat for the gasification of the feedstock material; e.g., vessel 302 operates as a furnace. The refractory material can insulate the interior cavity 304 of the vessel from the outer environment. In addition, the refractory material can be a solid with physical properties (thermal coefficient(s), elastic moduli, hardness, etc.) suitable for operation in a high-pressure (e.g., from about 25 psi to about 100 psi) and high-temperature (e.g., from about 1000° F. through about 1800° F.) environment. In an aspect, the vessel 302 is manufactured out of metal (alloyed or otherwise) and is dimensioned to enable transportation of pyrolysis chamber 206 in any or most any conventional road; for instance, length of pyrolysis chamber 206 along axis 309 can range from about 30 foot (ft) to about 60 foot, whereas width ranges from nearly 10 ft to nearly 12 ft and height ranges from about 10 foot to about 12 foot. Any other materials suitable for withstanding elevated pressures (e.g., from nearly 25 psi to nearly 100 psi) also can be utilized.

The vessel 302 is also can be coated with thermally insulating material; a suitable amount of the thermally insulating material can be installed to ensure a substantive lower temperature in the environment outside vessel 302 when compared with the operating temperature inside vessel 302. In FIGS. 3A-3B, the thermally insulating material can be a portion of the right-slanted dashed area.

Pyrolysis chamber 206 also includes an injection structure 307 (e.g., an injection chamber) that collects an amount of feedstock material to be supplied to metal drum 308. Injection structure 307 is functionally coupled to accumulation chamber 204; in an aspect, functional coupling is accomplished through direct attachment via one or more suitable means (e.g., welding, bolting, etc.). In additional or alternative embodiments, the injection structure 307 is part of the accumulation chamber 204. Attached to the injection structure 307 is a conduit 311 (e.g., pipe(s), tube(s), valve(s), or the like) that can receive specific amount(s) of steam at a predetermined controllable pressure to adjust moisture level, or content, of the amount of feedstock material that is introduced in metal drum 308 for gasification (e.g., primary gasification phase 120). The specific amount(s) of steam that are received through the conduit 311 can be based on various characteristics of the feedstock material 110, such as the amount of feedstock material 110 or the moisture level of the feedstock material 110. In one or more modes of operation accomplished in certain embodiments, conduit 311 also allows injection of water into the amount of feedstock material in the injection chamber 307; as described supra, in one or more scenarios, the water can be injected in a specific water-to-solid ratio ρ; e.g., ρ can range from about 1 to about 1.5. The specific value of the water-to-solid ration r depends at least in part on amount of carbon that is present in feedstock material 110. The conduit 311 can be attached to injection structure 307 by any suitable means (welding, bolting, etc.), and can be manufactured out of metal.

A group of one or more heating elements 312 (represented with grey-shaded rectangles in FIG. 3A) provide heat to the environment in cavity 304, which transfers heat to the metal drum 308 within the vessel 302. In the illustrated example embodiment, the group of one or more heating elements consists of five heating elements 312; however, it is noted that the number of heating elements is configurable and determined based at least on heat flow necessary to achieve a desired temperature that allows to gasify, at least in part, a specific amount of feedstock material 110 supplied to the pyrolysis chamber 206. In alternative or additional embodiments, a group of 36 heating elements can be deployed. In a scenario in which one or more sealed radiant tubes are utilized as heating element, relatively low BTU (British Thermal Unit) value process, or product, gas can be employed for combustion and source of heat.

Metal drum 308 houses feedstock material and has cylindrical symmetry or is substantially cylindrically symmetric; see, e.g., FIG. 3A. Metal drum 308 can rotate about its axis of symmetry or substantial symmetry, such axis is illustrated with a dot-dashed line and labeled as axis 309 in FIG. 3A; rotation can increase heat transfer amongst the feedstock material and increase efficiency of the primary gasification phase (e.g., 120). For a cylindrical metal drum, the axis of symmetry is the longitudinal axis of the cylindrical metal drum. A variable speed motor drive 310 provides the torque that enables rotational motion of metal drum 308. In addition, the variable speed motor drive 310 allows to control and to change the angular velocity of such rotational motion. Change or variation of the angular velocity of the rotational motion of metal drum 308 allows regulation of retention time (e.g., Δτ_{P}) of feedstock material within pyrolysis chamber 206 for primary gasification phase (e.g., 120). In alternative embodiments, a dedicated variable speed motor drive enables regulated rotation (e.g., angular velocity is varied and controlled to be within a predetermined range of fluctuation) of metal drum 308.

Metal drum 308 includes a set of openings (not shown) for release of feedstock by-product (not shown) via discharge structure 318. In addition, metal drum 308 includes a flight structure comprising one or more sets of flights; such structures are represented as crossed segments in FIG. 3B. Discharge structure 318 (not shown in FIG. 3B) is suitably manufactured to partially wrap around metal drum 308 to enable collection of the feedstock by-product. Discharge structure 318 is terminated with one or more air-lock valves (black short segments) and an accumulation chamber 328.

In the embodiment illustrated in FIG. 3A, a set of five exhaust pipes, or gas collection pipes 332, stream any produced gas (e.g., 124) out of the pyrolysis chamber 206; the streamed gas is pyrolysis gas. It should be appreciated that the number of exhaust pipes can be different in additional or alternative embodiments.

In example gasification system 200, as a result of primary gasification, pyrolysis chamber 206 supplies gas (e.g., pyrolysis gas) to a steam reformation reactor 230, the gas (e.g., pyrolysis gas) is provided at elevated pressure P_{P}, e.g., a pressure in the range from about 25 psi to about 100 psi. The supplied gas (e.g., pyrolysis gas) is represented with a set of open arrows in FIG. 2. The steam reformation reactor 230 can be embodied, in part, in a set of metal coils 232 that receive steam from steam source(s) 240. The elevated pressure P_{P} (e.g., at least about 25 psi) at which gas (e.g., pyrolysis gas) is produced in the pyrolysis chamber 206, as part of primary gasification phase, enables the syngas to circulate through the set of metal coils. The set of metal coils are designed and constructed to allow a predetermined resonance, or residency, time Δτ_{R} during which the reaction with steam is sustained. In one or more embodiments, Δτ_{R}≦10 s, e.g., 3 s≦Δτ_{R}≦5 s; in additional or alternative embodiments Δτ_{R} can be about 10 s. In one or more embodiments, the metal employed in a coil can be a simple metal, while in additional or alternative embodiments, the metal employed to manufacture a coil in the set of coils can be a high-temperature alloy, with suitable physical properties, such as high-temperature tensile strength and abrasion resistance. It is noted, however, that any simple metal or alloyed metal can be utilized to manufacture the set of metal coils. The steam reformation reactor 230 also can include a structure 235 that allows size fluctuations or shape fluctuations of the set of metal coils in one or more directions and constrain deformations in a disparate direction. In addition, the steam reformation reactor 230 operates at a specific temperature (T_{R}) and with a predetermined partial pressure of steam, which generally is superheated steam. The temperature T_{R} generally is above the temperature at which primary gasification phase is conducted in pyrolysis chamber. For example, in certain embodiments, T_{R} is greater than about 1700° F. In additional or alternative embodiments, T_{R} is at least 1200° F. In certain embodiments, T_{R} is. Steam reformation results in reacted syngas that has a predetermined molecular-hydrogen-to-carbon-monoxide (H₂/CO) ratio, which is regulated, in part, by T_{R} and partial pressure of superheated steam. In an aspect, the syngas incoming in the steam reformation reactor 230 is reacted to saturation; namely, T_{R} and partial pressure of steam, or ratio of steam to carbon, are configured to values that yield the ideal or nearly ideal H₂/CO ratio for the syngas that is reacted. It should be appreciated that the ideal or nearly ideal H₂/CO ratio for the syngas that is reacted depends in part on the type of intended application of such syngas; for instance, if the reacted syngas is intended for liquid fuels, a H₂/CO ratio of 2:1 is ideal.

In one or more embodiments, the steam source(s) 240 can include a boiler and additional structure to recover dissipated heat (e.g., heat from exhaust conduit(s)) from one or more of the pyrolysis chamber 206, solids reactor 210, and steam reformation reactor 230. Water for generation of steam can be supplied at least from a water recuperation loop that is part of a syngas clean-up phase (e.g., 160); as an example, water can be collected from a condenser 260 and a water cleansing circuit that includes tank 270, filter(s) 280, and cooling tower 290. In an aspect, condenser 260 reduces temperature and removes at least a portion of moisture of clean saturated syngas received from a wet scrubber that is part of the cleaning platform 250; in certain scenarios, temperature of the clean saturated syngas is reduced to at least about 75° F. Removed moisture is streamed into accumulation tank 270 for subsequent filtering and recuperation in tank 295.

As described supra, by-product solid matter (e.g., 128) is transferred to solids reactor 210, which performs a secondary gasification phase (e.g., 130) that results in additional syngas and disposable material. As described supra, temperature of the by-product solid matter (e.g., 128) can be increased up to about 1750° F. in order to gasify any or most any organic material that remains within the amount of by-product solid matter that is injected in the solids reactor 210. In an embodiment, the solids reactor 210 can receive streams of by-product solid matter from a plurality of pyrolysis chambers. Utilization of two or more pyrolysis chambers (or any suitable gasification chambers) can result in each of the two or more pyrolysis chambers receiving smaller loads of feedstock material; however, the two or more pyrolysis chambers can be manufactured with dimensions adequate for conventional transportation and related logistics (e.g., no need of special delivery vehicles or permits or transportation conditions). In such embodiment, the plurality of pyrolysis chambers is deployed instead of pyrolysis chamber 206, wherein each pyrolysis chamber can operate in substantially the same or the same manner as pyrolysis chamber 206. At least one advantage of a non-combustion gasification system that includes a plurality of pyrolysis chambers is that production rate of syngas can be increased without straining the capacity of the secondary solids reactor 210 to gasify feedstock by-product. In additional or alternative embodiments, the plurality of pyrolysis chambers can be separated in groups operationally coupled to a plurality of secondary solid reactors.

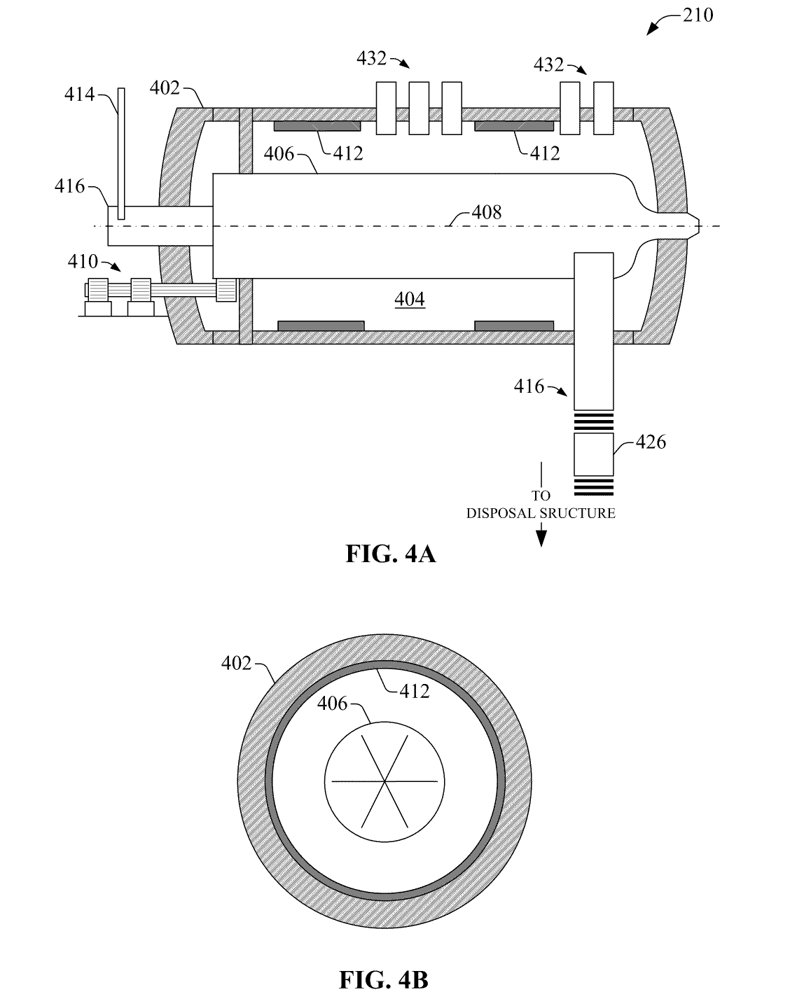

In one or more embodiments, such as in the example embodiment illustrated in FIGS. 4A-4B, the solids reactor 210 is a vessel 402 with an inner surface coated, or lined, with a refractory material that enables heat retention in environment 404 and thermal insulation with external environment; the retained heat is utilized for the gasification of the feedstock by-product material. The vessel 402 is a source of the heat for the gasification of the feedstock material; e.g., vessel 402 operates as a furnace. The refractory material of the solid reactor 210 can have substantially the same physical properties as the refractory material that coats the interior of pyrolysis chamber 206. In an aspect, the vessel 402 is manufactured out of metal (alloyed or otherwise); however, any material suitable to withstand high pressures (e.g., at least 25 psi) can be utilized. In certain embodiments, the vessel 402 is also coated with thermally insulating material in addition to the refractory material; a suitable amount of the thermally insulating material is installed to ensure a substantive lower temperature in the environment outside the vessel 402 when compared with the operating temperature of solids reactor 210. In FIGS. 4A-4B, the thermally insulating material can be a portion of the right-slanted dashed area.

A group of one or more heating elements 412, such as sealed radiant tubes, an electrical element or other external source of heat, provide heat to cavity 404, which transfers heat to a metal drum 406 within the vessel 402, the metal drum houses the received feedstock by-product material and has cylindrical symmetry or is substantially cylindrically symmetric. In a scenario in which one or more sealed radiant tubes are utilized as heating element, relatively low BTU (British Thermal Unit) value process, or product, gas can be employed for combustion and source of heat.

Solids reactor 210 also includes an injection structure 416 (e.g., an injection chamber) that collects by-product solid matter (e.g., solid material 128) to be supplied to metal drum 406. Attached to injection structure 416 is a conduit 414 (pipe(s), tube(s), valve(s), etc.) that can receive specific amounts of steam to adjust moisture level of the feedstock by-product solid matter that is introduced in the metal drum 406 for gasification (e.g., secondary gasification phase 130. The conduit 414 can be attached to injection structure 416 by any suitable means (welding, bolting, etc.).

The metal drum 406 can rotate about its axis of symmetry or substantial symmetry, such axis is illustrated in FIG. 4A with a dot-dashed line and labeled with numeral reference 408; such rotation can increase heat transfer amongst the feedstock by-product material and increase efficiency of the secondary gasification phase (e.g., 130). Similar to example embodiment of pyrolysis chamber 206 described supra, a motor drive 410 provides torque that enables the rotational motion of the solids reactor 210. In addition, motor drive 410 allows to control and to change the angular velocity ω_{S} of the rotational motion. Change or variation of the angular velocity ω_{S} of the rotational motion of metal drum 406 allows regulation of retention time (Δτ_{S}) of by-product material that is gasified within metal drum 406.

Metal drum 406 includes a set of openings (not shown) for release of disposable solid matter (not shown) via a discharge structure 418. In addition, the metal drum 406 includes a flight structure comprising one or more sets of flights; such structure is represented as crossed segments in FIG. 4B. Discharge structure 418 (not shown in FIG. 4B) is suitably manufactured to partially wrap around metal drum 406 and collect disposable material (e.g., 138). In addition, the discharge structure 418 is terminated with one or more air-lock valves (black thick segments) and an accumulation chamber 426; the one or more air-lock valves enable depressurization of the disposable material prior to conveyance to a disposal structure (e.g., 220).

In the illustrated embodiment, a set of five exhaust pipes, or collection pipes, 432 stream any produced synthesis gas (e.g., 134) out of the solid reactor 210. It should be appreciated that the number of exhaust pipes can be different in additional or alternative embodiments.

In example gasification system 200, syngas produced in the solids reactor 210 can be conveyed to steam reformation reactor 230, whereas the disposable material (e.g., 138) can be discarded through disposal structure 220. Deployment (e.g., installation, testing, acceptance, and maintenance) of disposal structure 220 increases duration of the example multi-phase gasification system 200 through mitigation of transfer of disposable solids (ash, tar, mineral impurities, etc.) through steam reformation reactor 230; particularly, though not exclusively, through the set of metal coils 232. In an embodiment, the disposal structure 220 is a coolant-jacketed auger that removes, or ejects, the disposable material (e.g., 138) at a discharge end of solids reactor 210. The coolant can be water (at ambient temperature or refrigerated) or other liquid fluid that extracts heat as the auger ejects the disposable solids; the material of the auger can be substantially any simple metal, metal alloy, or ceramic alloy with physical properties suitable for operation in a high-pressure, high-temperature and high-abrasion environment. A set of air-lock valves 222 maintain operating pressure, e.g., a pressure in the range from nearly 25 psi to nearly 100 psi, of the solids reactor 210 in accumulation vessel 224 as the coolant-jacketed auger operates. As described supra, the set of air-lock valves 222 and accumulation vessel 224 mitigate (i) uncontrolled oxidation and ensuing combustion of the disposable material and (ii) uncontrolled ejection of the high-pressure disposable material. Similarly to accumulation chamber 204, accumulation vessel 224 includes at least one control valve that holds positive pressure (e.g., a pressure in the range of about 25 psi to about 100 psi) when the disposal material is released to the accumulation vessel 224. The at least one control valve also enables decompression of the accumulation vessel 224.

Syngas that is reacted in the steam reformation reactor 230 is conveyed to a cleaning platform 250 as part of a clean-up phase (e.g., 160). The cleaning platform 250 can include one or more of a set of scrubbing apparatus(es) (a wet scrubber, a dry scrubber, a filter etc.) or a set of cyclones; wherein the one or more cyclones in the set of cyclones can be employed for ash separation. In the illustrated example gasification system, cleaning platform 250 includes a wet scrubber, which can be a Venturi wet scrubber that exploits a liquid coolant, such as water, and can remove a substantive amount (e.g., 90-95%) of particles with typical sizes of the order of a micrometer or smaller; e.g., particulate matter with sizes below 1 μm. Operating pressure (e.g., about 25 psi to about 100 psi) in example non-combustion gasification system 200 can convey scrubbing water to accumulation tank 270, or accumulation tank 270. Collected water can be filtered through filter(s) 280, which can include screen filter(s), dual-media sand filter(s), bag filter(s), or the like. Recycled, filtered scrubbing water is circulated through cooling tower structure 290 (also referred to as cooling tower 290 in the subject disclosure) and collected in tank 295, or accumulation tank 295. Condenser 260, filter(s) 280, cooling tower 290, and accumulation tank 295 form at least part of a water recuperation circuit which is closed by the wet scrubber that is part of cleaning platform 250 and accumulation tank 270. Recuperated or recycled water can be reintroduced in the wet scrubber in cleaning platform 250. In addition, as indicated supra, recycled water can be utilized for steam generation.

Design of example gasification system 200 is modular and can be deployed in substantially any location with access to feedstock supplies. Pyrolysis chamber 206 and solids reactor 210 are dimensioned to enable transportation in standard roads without incurring or warranting especial transportation conditions, such as need of escort vehicles. Therefore, costs associated with transportation can be contained, which increases commercial viability of example non-combustion gasification system 200 and structure, components, and equipment thereof. Other equipment or structures employed in example gasification system 200 also are dimensioned so as to allow ease of transportation.

In addition, and in contrast to certain conventional gasification systems for production of syngas, the multi-phased gasification process (e.g., 100) and related example multi-phased gasification system 200 described herein can produce syngas without reliance in complex materials, such as ionized, electrostatically enhanced water, or complex structures such as those that provide ionized, electrostatically enhanced water or other types of chemically processed water.

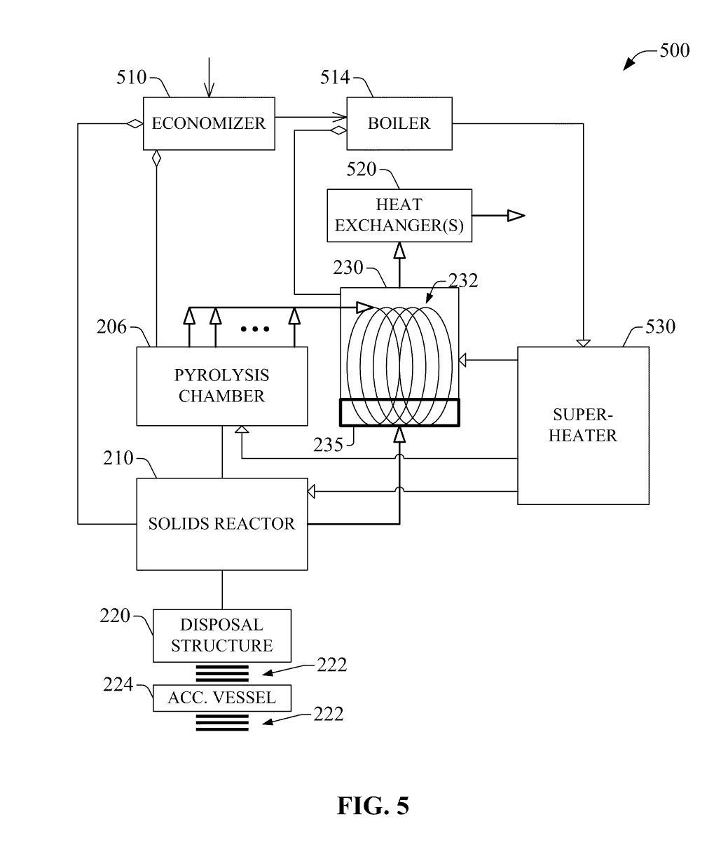

FIG. 5 presents a block diagram 500 of a portion of the example multi-phased gasification system 200 and components for steam production in accordance with aspects described herein. The components for steam production can embody steam source(s) 240. As discussed supra, steam utilized in the multi-phased gasification process disclosed herein can be produced through reutilization of one or more of product of combustion (POC) dissipated heat or inherent heat contained in produced synthesis gas. In the illustrated embodiment, an economizer structure 510, also referred to as economizer 510 in the subject disclosure, is utilized to heat water from ambient temperature to a predetermined high temperature (e.g., at least about 300° F.). Economizer 510 exploits, at least in part, one or more POC dissipated heat flows (indicated with diamond-shaped arrows) generated at one or more of pyrolysis chamber 206, or solids reactor 210. Heater water from the economizer is supplied to boiler 514 which produces steam. POC dissipated heat generated at steam reformation reactor 230 is conveyed to a boiler 514; steam (indicated with a short, flat open arrow in diagram 500) generated at such boiler is streamed to super-heater 530. In additional or alternative embodiments, boiler 514 can be part of economizer 510, e.g., part of structure therein that is employed to heat water from ambient temperature to the predetermined high temperature. At least a portion of the water that is heated in the economizer 510 can originate from a water recuperation loop, e.g., condenser 260, filter(s) 280, cooling tower 290, tank 295. Reutilization of water increases efficiency of the multi-phased gasification process and equipment (e.g., example gasification system 200) that carry out such process. In addition, reutilization of water can enable, in part, deployment of such equipment (e.g., example gasification system 200) in remote locations with limited access to water or where water is obtained through costly process(es) such as desalinization.

In an aspect, raw syngas is supplied to heat exchanger(s) 520, which can increase the temperature of a flow of combustion air as it circulates through the heat exchanger 520. In an aspect, the one or more heat exchangers can include various heat exchangers, including gas-to-gas heat exchanger(s) or liquid-to-gas heat exchanger(s). Such combustion air is part of the closed circuit (not shown in FIG. 5) that streams air into various combustion processes. Heated combustion air can be supplied to the various combustion processes, which heat, for example, pyrolysis chamber 206 or solids reactor 210. To increase the temperature, the reformed syngas exits steam reformation reactor 230 at high temperature (e.g., at about T_{R}) circulates through heat exchanger 520 and transfers heat to the flow of steam, which increases its temperature. As a result of heat transfer, temperature of the raw syngas that circulates in the heat exchanger 520 is reduced to a value T_{low}; in the subject disclosure, T_{low} is substantially equal to or greater than 1000° F., which avoids tar formation as a result of condensation of impurities in the raw syngas.

Magnitude of temperature increase ΔTₛ of the flow of steam ranges from about 100° F. to several hundred ° F.; ΔTₛ depends on design factors such as elements or parts, and sizes thereof, of the one or more heat exchangers 520, mechanism(s) of heat transfer exploited by the heat exchanger 520, and temperature of the raw syngas that supplies the heat excess. As an example, in certain embodiments, ΔTₛ=300° F., wherein the initial temperature of the flow of steam can be nearly 300° F.

A flow of heated steam at temperature Tₕ, e.g., at least 600° F., is supplied to super-heater structure 530, also referred to as super-heater 530 in the subject disclosure, to further increase the temperature of the heated steam to at most about 1750° F. Super heated steam flow(s) (indicated with short, flat open arrows in diagram 500) are supplied to one or more of steam reformation reactor 230, pyrolysis chamber 206, or solids reactor 210.

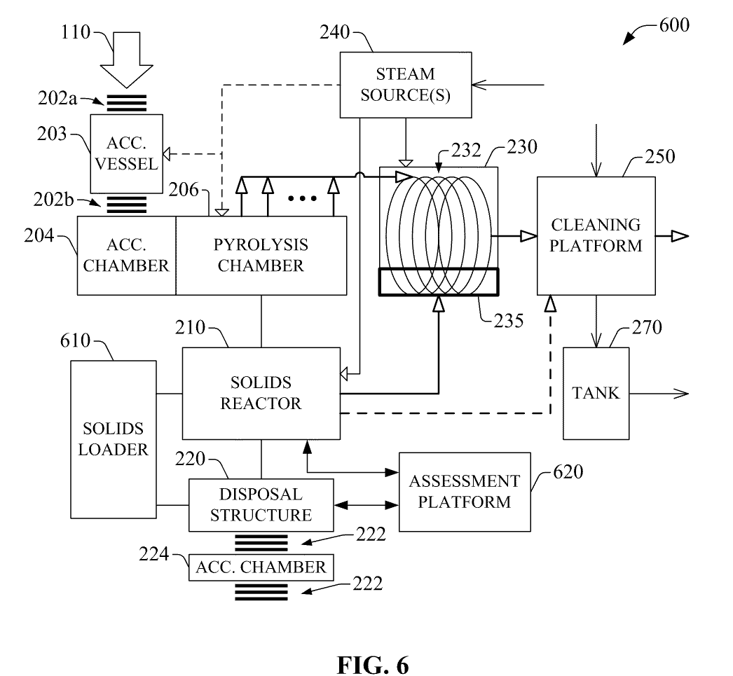

FIG. 6 presents a block diagram 600 of an example multi-phased gasification system 600 in accordance with aspects described herein. A solids loader structure 610, also referred to as solids loader 610, can inject disposable solid matter (e.g., 138) retained in accumulation vessel 224 into solids reactor 210 for additional gasification. Solids loader 610 can be controlled by an assessment platform 620, which can analyze the disposable solid matter in accumulation vessel 224 and, based on the analysis, determine if implementation of an additional gasification cycle in solids reactor 210 of the disposable solid matter is warranted. Disparate density of various components of disposable solid matter can result in separation of more dense material, which can be more likely to be reformed into syngas in the additional cycle of gasification than less dense material such as ash(es). To analyze the disposable solid matter, assessment platform 620 can collect spectroscopic data or thermochemical data in situ, e.g., in accumulation vessel 224; such data in conjunction with a set of criteria, e.g., predetermined composition of probed material, can establish if additional gasification is warranted. The set of criteria can be stored in a memory or memory element (database, register, file(s), etc.) within assessment platform 620 or functional coupled thereto. In an aspect, assessment platform 620 autonomously or automatically assesses if additional cycles of a secondary gasification phase can be beneficial to syngas yield of the example gasification system 600, or any other gasification system described herein.

In addition, or in the alternative, assessment platform 620 also can analyze produced syngas (e.g., 134) in solids reactor 210, and based at least on such analysis it can establish that the quality of the produced syngas is sufficient to convey the syngas to a clean-up phase (e.g., 160) instead of a steam reformation phase (e.g., 140). Data collected as part of the analysis can be contrasted with a set of quality criteria to establish if quality of syngas warrants bypassing the steam reformation reactor 230. In certain embodiments, assessment platform 620 also can analyze a sample of feedstock material 110 and determine that carbon content in the feedstock material is sufficiently low so as not to justify steam reaction, and thus syngas produced in the solids reactor 210 can be supplied directly to the clean-up phase (e.g., 160).

It should be noted that the added complexity (structural and procedural) of the analysis conducted by assessment platform 620 and deployment and operation of solids loader 610 can outweigh the cost of disposing solid matter with reformation value, e.g., solid matter than can yield syngas upon gasification, particularly though not exclusively in operational locations in which feedstock is costly, such as in remote locations, or during unusual operational conditions, e.g., stored feedstock is unusable because of poor storage conditions. Similarly, complexity of analysis of produced syngas can outweigh the cost of circulating syngas into steam reformation reactor 230, for example, in conditions in which steam reformation reactor 230 or steam source(s) 240 operate under capacity.

In one or more embodiments, assessment platform 620 can exploit artificial intelligence (AI) methods to generate the foregoing assessment(s) without human intervention as described supra. Such intelligence can be generated through inference, e.g., reasoning and conclusion synthesis based upon a set of metrics, arguments, or known outcomes in controlled scenarios, or training sets of data. Artificial intelligence methods or techniques referred to herein typically apply advanced mathematical algorithms—e.g., decision trees, neural networks, regression analysis, principal component analysis (PCA) for feature and pattern extraction, cluster analysis, genetic algorithm, or reinforced learning—to a data set.

Such methodologies can include, for example, Hidden Markov Models (HMMs) and related prototypical dependency models can be employed. General probabilistic graphical models, such as Dempster-Shafer networks and Bayesian networks like those created by structure search using a Bayesian model score or approximation can also be utilized. In addition, linear classifiers, such as support vector machines (SVMs), non-linear classifiers such as methods referred to as “neural network” methodologies, fuzzy logic methodologies can also be employed. Moreover, game theoretic models and other approaches that perform data fusion, etc., can be exploited.

Processor(s) (not shown) can be configured to provide or can provide, at least in part, the described functionality of an assessment platform, or components therein, that can determine whether quality of produced synthesis gas in a secondary gasification phase (e.g., 130) warrants bypassing a steam reformation phase, or spectral properties of disposable solid(s) indicated that further gasification can be achieved through implementation of an additional cycle of the secondary gasification phase.

In an aspect, to provide such functionality, the processor(s) can exploit a bus that can be part of the assessment platform to exchange data or any other information amongst components therein and a memory (not shown) or elements therein, such as or algorithm store, data store, or monitoring logic, etc. The bus can be embodied in at least one of a memory bus, a system bus, an address bus, a message bus, or any other conduit, protocol, or mechanism for data or information exchange among components that execute a process or are part of execution of a process. The exchanged information can include at least one of code instructions, code structure(s), data structures, or the like.

It is noted that the various example gasification systems described herein include equipment, components, or other structure for automated control of the various portions of the multi-phased gasification process disclosed herein. The equipment, components, or other structure for automated control can be deployed and configured (e.g., programmed) in accordance with various aspects described herein and via conventional and novel control paradigms, mechanisms, or programming.

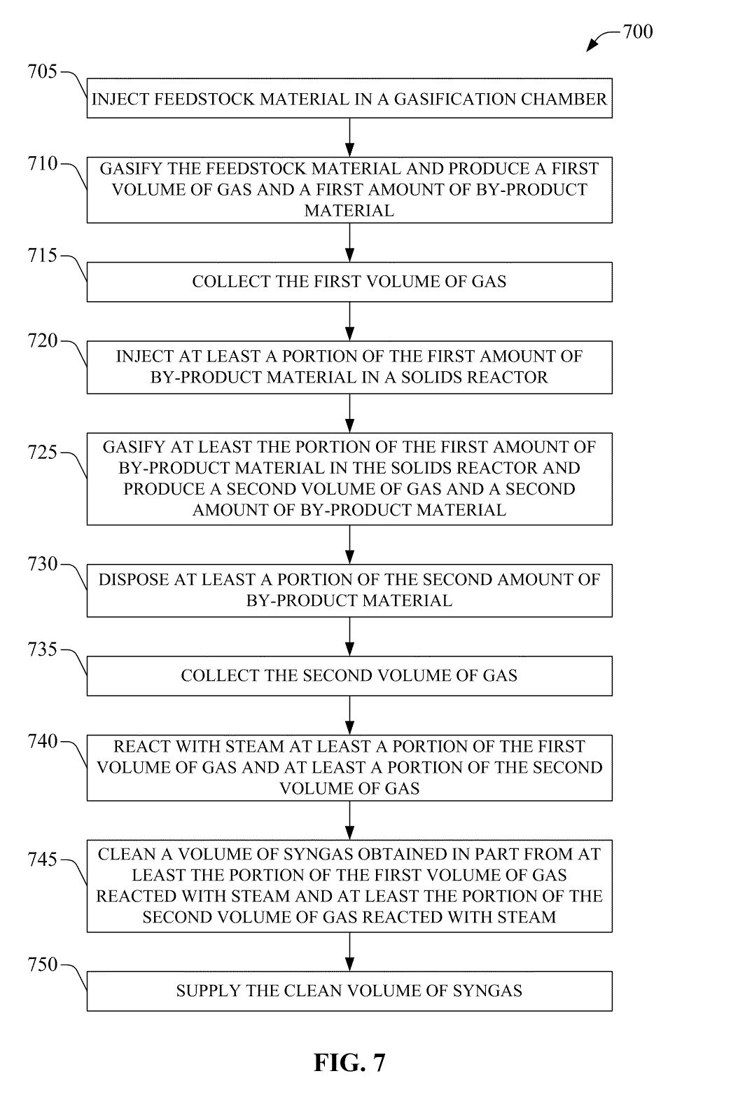

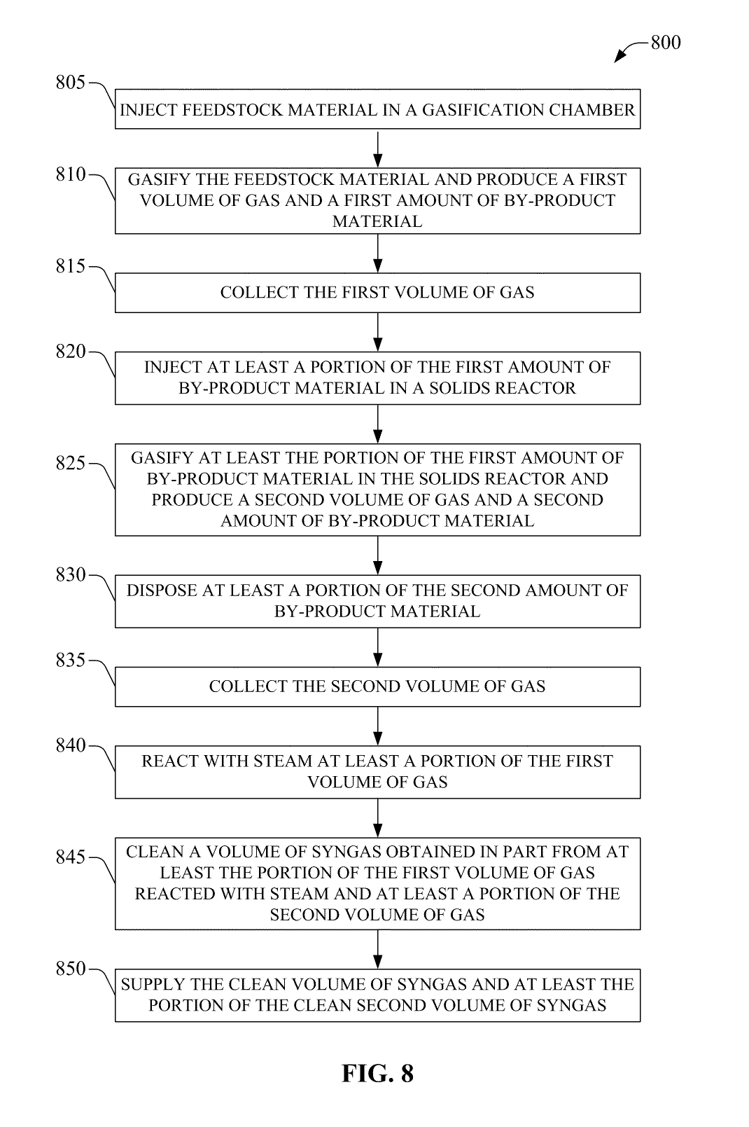

In view of the example systems described above, example process(es) that can be implemented in accordance with the disclosed subject matter can be better appreciated with reference to flowcharts in FIGS. 7-8. For purposes of simplicity of explanation, example processes disclosed herein are presented and described as a series of acts; however, it is to be understood and appreciated that the disclosed subject matter is not limited by the order of acts, as some acts may occur in different orders and/or concurrently with other acts from that shown and described herein. For example, one or more example processes disclosed herein can alternatively be represented as a series of interrelated states or events, such as in a state diagram. Moreover, interaction diagram(s) may represent methods in accordance with the disclosed subject matter when disparate entities enact disparate portions of the methodologies. Furthermore, not all illustrated acts may be required to implement a described example process in accordance with the subject disclosure. Further yet, two or more of the disclosed example processes can be implemented in combination with each other, to accomplish one or more features or advantages described herein.

FIGS. 7-8 present flowcharts of example processes for producing synthesis gas through non-combustion gasification of feedstock in accordance with aspects of the subject disclosure. At least one or more portions (e.g., sets of acts) of the subject example processes can be effected in batch mode with a high interval operation (e.g., a short batch time span, such as about 1 min to about 10 min), in semi-continuous mode, or in continuous mode. In addition, in the subject example methods, in an aspect, the gasification of feedstock is accomplished through non-combustion gasification process(es), such as pyrolysis; however, it should be appreciated that other thermodynamic process(es) also can be utilized.

Regarding example method 700, at act 705, feedstock material is injected in a gasification chamber. In certain embodiments, the gasification chamber is embodied in one or more pyrolysis chambers. As described supra, injecting the feedstock material can include removing air there from, to ensure the gasification does not include combustion reactions which can produce tars and other oxidant-based contaminants. In addition, in one or more embodiments, the injecting act can include injecting a volume of steam into the gasification chamber; injecting the volume of steam allows controlling, to certain degree, the composition of produced synthesis gas during gasification. The volume of steam can be superheated at a temperature of at least 1200° F. Moreover, as described supra, the injecting act can include mixing the feedstock material with water in a specific water-to-solid ratio ρ (with ρ a real number); from example, ρ can range from nearly 1 to nearly 1.5. At act 710, the feedstock material is gasified and a first volume of gas (e.g., gas 124) and a first amount of by-product material are produced. The feedstock material is gasified at a first temperature and a first pressure in the range from about 25 psi to about 100 psi, and the first temperature ranges from about 1000° F. to about 1750° F. In an aspect, as described supra, if gasifying the feedstock material is accomplished in one or more pyrolysis chambers (see, e.g., FIGS. 2 and 3A), the gas in the first volume of gas is pyrolysis gas, which includes synthesis gas and other gases comprising heavier molecules. The by-product material includes solid matter that has been partially decomposed rather than fully transformed into gas (e.g., pyrolysis gas).

At act 715, the first volume of gas (e.g., pyrolysis gas) is collected. In an aspect, the collecting act includes releasing the first volume of gas (e.g., pyrolysis gas) into a reactor for steam reformation via a set of gas collection structures, such as pipes and regulation valves (see, e.g., FIG. 2). At act 720, at least a portion of the first amount of by-product material is injected in a solids reactor (e.g., 210). In one or more embodiments, the injecting act can include injecting a volume of steam into the gasification chamber; injecting the volume of steam allows controlling, to certain degree, the composition of produced synthesis gas (e.g., 134) during gasification. At act 725, at least the portion of the first amount of by-product material is gasified and a second volume of gas and a second amount of by-product material are produced. In an aspect, the gas in the second volume of gas can be substantially synthesis gas (syngas). In one or more embodiments, the gasifying in the subject act is accomplished within the solids reactor through a gasification process that is the same or substantially the same as the gasification process in act 710. The gasifying at act 725, however, can be conducted at different temperature (e.g., a higher temperature) or different pressure (e.g., a lower pressure) than the gasifying performed at act 710. In an aspect, as described supra, the temperature at which at least the portion of the first amount of by-product material is gasified is at most about 1750° F., whereas the pressure at which at least the portion of the first amount of by-product material is gasified ranges from 25 psi to 100 psi. At act 730, at least a portion of the second amount of by-product material is disposed. At act 735, the second volume of gas (e.g., syngas) is collected. In an aspect, the collecting act includes releasing the second volume of syngas in the reactor for steam reformation.

At act 740, at least a portion of the first volume of gas (e.g., pyrolysis gas) and at least a portion of the second volume of gas (e.g., syngas) are reacted with steam within the reactor for steam reformation (e.g., 230). As discussed supra, the second volume of gas (e.g., syngas) is reacted with a volume of superheated steam at a reaction temperature T_{R} for a predetermined time Δτ_{R}. At act 745, a volume of syngas obtained in part from at least the portion of the first volume of gas (e.g., pyrolysis gas) reacted with steam and at least the portion of the second volume of gas (e.g., syngas) reacted with steam is cleaned. The cleaning can be conducted in a cleaning platform (e.g., 250), which includes scrubbing apparatus(es) (e.g., wet scrubber, dry scrubber) or other cleaning structure (e.g., one or more cyclones); in certain embodiments, the other cleaning structure can be functionally coupled to the scrubbing apparatus(es) for cleaning the volume of syngas. At act 750, the clean volume of syngas is supplied.

Regarding example method 800, at act 805, feedstock material is injected in a gasification chamber. Injecting the feedstock material can include removing air there from, to ensure the gasification does not include combustion reactions, which can produce tars and other oxidant-based contaminants. In addition, the injecting act can include injecting a volume of steam into the gasification chamber; injecting the volume of steam allows controlling, to certain degree, the composition of produced gas (e.g., gas stream 124) during gasification. In an aspect, the volume of steam can be superheated at a temperature of at least 1200° F. Moreover, the injecting act can include mixing the feedstock material with water in a specific water-to-solid ratio ρ (a real number); from example, ρ can range from nearly 1 to nearly 1.5. At act 810, the feedstock material is gasified and a first volume of gas and a first amount of by-product material are produced. In an aspect, as described supra, the temperature at which at least the portion of the first amount of by-product material is gasified is at most about 1750° F., whereas the pressure at which at least the portion of the first amount of by-product material is gasified ranges from 25 psi to 100 psi. In another aspect, as described supra, if gasifying the feedstock material is accomplished in one or more pyrolysis chambers (see, e.g., FIGS. 2 and 3A), the gas in the first volume of gas is pyrolysis gas, which includes synthesis gas and other gases comprising heavier molecules. The by-product material includes solid matter (char, ash, etc.) that has been partially decomposed or gasified rather than fully transformed into gas (e.g., pyrolysis gas).

At act 815, the first volume of gas (e.g., pyrolysis gas) is collected. In an aspect, the collecting includes releasing the first volume of gas (e.g., pyrolysis gas) into a reactor for steam reformation, such as reactor 230, via a set of gas collection structures, such as pipes and regulation valves (see, e.g., elements 332 in FIG. 3A). At act 820, at least a portion of the first amount of by-product material is injected in a solids reactor (e.g., 210). In one or more embodiments, the injecting act can include injecting a volume of steam into the solids reactor (e.g., 210); injecting the volume of steam allows controlling, to certain degree, the composition of produced synthesis gas (e.g., 134) during gasification. In an aspect, a conduit (e.g., 414) functionally coupled (e.g., affixed) to the solids reactor (e.g., 210) enables injecting the volume of steam. At act 825, at least the portion of the first amount of by-product material is gasified and a second volume of gas and a second amount of by-product material are produced. In another aspect, the gas in the second volume of gas can be substantially synthesis gas (syngas). In one or more embodiments, the gasifying in the subject act is accomplished within the solids reactor via a gasification process that can be the same or substantially the same as the gasification process in act 810. The gasifying at act 825, however, can be conducted at different temperature (e.g., a higher temperature) or different pressure (e.g., a lower pressure) than the gasifying act performed at act 810. In an aspect, as described supra, the temperature at which at least the portion of the first amount of by-product material is gasified is at most about 1750° F., whereas the pressure at which at least the portion of the first amount of by-product material is gasified ranges from 25 psi to 100 psi. At act 830, at least a portion of the second amount of by-product material is disposed. At act 835, the second volume of gas (e.g., syngas) is collected. In yet another aspect, based on quality of the second volume of gas (e.g., syngas), the collecting act includes bypassing injection of the second volume of gas (e.g., syngas) into the reactor for steam reformation (e.g., steam reformation reactor 230) and injecting the second volume of syngas directly into a cleaning platform (e.g., 250), which can include one or more of scrubbing apparatus(es) (wet scrubber(s), dry scrubber(s), filter(s), etc.) or other cleaning structure (e.g., one or more cyclones), that enables cleaning the second volume of gas.

At act 840, at least a portion of the first volume of gas (e.g., pyrolysis gas) is reacted with steam within the reactor for steam reformation. At act 845, a volume of syngas obtained in part from at least the portion of the first volume of gas (e.g., pyrolysis gas) reacted with steam and at least the portion of the second volume of gas (e.g., syngas) reacted with steam is cleaned. The cleaning can be conducted in the cleaning platform (e.g., 250), or any part thereof (a wet scrubber, a dry scrubber, a cyclone, a filter, etc.). In an aspect, as described supra, cleaning at least the portion of the second volume of gas (e.g., syngas) includes collecting the second volume of gas directly from the solids reactor. In one or more embodiment, the cleaning of at least the portion of the second volume of gas (e.g., syngas) includes comprises analyzing a chemical composition of the second volume of gas (e.g., syngas) and, based at least on the chemical composition, bypassing the reactor for steam reformation (e.g., steam reformation reactor 230), as described supra. At act 850, the clean volume of syngas and at least the clean portion of the second volume of syngas are supplied.

As described supra, the supplying acts 750 and 850 include streaming, or delivering, at least a first portion of clean syngas into one or more combustion lines that produce heat for gasification phase(s), steam reformation, and other processes that can be part of the multi-phase gasification of feedstock described herein. In addition, supplying acts 750 and 850 also can include converting at least a second portion of clean syngas into fuel for operating an electricity generator, which can power up one or more structures (e.g., motor drives that rotate the set of drums in pyrolysis chamber 206 or within solids reactor 210) that enable the multi-phased gasification of feedstock disclosed herein.

As employed in the subject disclosure, the term “relative to” means that a value A established relative to a value B signifies that A is a function of the value B. The functional relationship between A and B can be established mathematically or by reference to a theoretical or empirical relationship. As used herein, coupled means directly or indirectly connected in series by wires, traces or other connecting elements. Coupled elements may receive signals from each other.

In the subject disclosure, terms such as “store,” “data store,” data storage,” and substantially any term(s) that convey other information storage component(s) relevant to operation and functionality of a functional element (e.g., a platform) or component described herein, refer to “memory components,” or entities embodied in a “memory” or components comprising the memory. The memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of further illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Certain illustrative components or associated sub-components, logical blocks, modules, and circuits, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, certain steps or actions (or acts) of a process, method, or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, in some aspects, certain steps or acts of a process, method, or algorithm may reside as one or any combination or set of codes or instructions on a machine readable medium or computer readable medium, which may be incorporated into a computer program product.

While the foregoing disclosure discusses illustrative aspects and/or embodiments, it should be noted that various changes and modifications could be made herein without departing from the scope of the described aspects and/or embodiments as defined by the appended claims. In addition, although elements of the described aspects and/or embodiments may be described or claimed in the singular, the plural is contemplated unless limitation to the singular is explicitly stated. Moreover, all or a portion of any aspect and/or embodiment may be utilized with all or a portion of any other aspect and/or embodiment, unless stated otherwise. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A process, comprising:
injecting feedstock material into a gasification chamber;
gasifying the feedstock material in the gasification chamber at a first temperature and a first pressure in a range of about 25 psi to about 100 psi, and producing a first volume of gas and a first amount of by-product material;
injecting at least a portion of the first amount of by-product material into a solids reactor; and
gasifying at least the portion of the first amount of by-product material in the solids reactor at a second temperature and a second pressure in a range of about 25 psi to about 100 psi, and producing a second volume of gas and a second amount of by-product material.

2. The process of claim 1, wherein injecting the feedstock material into the gasification chamber includes injecting a volume of steam into the gasification chamber, wherein the volume of steam is superheated at a temperature of at least about 1200° F.

3. The process of claim 1, wherein injecting the feedstock material into the gasification chamber includes mixing the feedstock material with water, wherein mixture of water with the feedstock material has a water-to-solid ratio that ranges from about 1 to about 1.5, a value of the water-to-solid ratio is based at least on amount of carbon present in the feedstock material.

4. The process of claim 1, wherein gasifying the feedstock material in the gasification chamber at the first temperature includes heating a metal drum that resides within the gasification chamber to substantially the first temperature, where the first temperature is in the range of about 1000° F. to about 1750° F.

5. The process of claim 1, wherein gasifying at least the portion of the first amount of by-product material in the solids reactor at the second temperature includes heating a single metal drum that resides within the solids reactor to substantially the second temperature, where the second temperature is at most about 1750° F.

6. The process of claim 1, further comprising: disposing at least a fraction of the second amount of by-product material.

7. The process of claim 1, further comprising:
reacting at least a part of the first volume of gas and at least a part of the second volume of gas with steam and producing a flow of reacted synthesis gas, wherein gas in the first volume of gas is pyrolysis gas, and gas in the second volume of gas is substantially synthesis gas; and
cleaning the flow of reacted synthesis gas.

8. The process of claim 1, further comprising:
reacting at least a part of the first volume of gas with steam and producing a flow of reacted synthesis gas, wherein gas in the first volume of gas is pyrolysis gas;
cleaning the flow of reacted synthesis gas; and
cleaning at least a part of the second volume of gas, wherein gas in the second volume of gas is substantially synthesis gas.

9. The process of claim 1, wherein injecting at least the portion of the first amount of by-product material into the solids reactor includes injecting a volume of steam into the solids reactor, wherein the volume of steam is superheated at a temperature of at least about 1200° F.

10. The process of claim 7, wherein the cleaning includes circulating the flow of reacted synthesis gas through a scrubbing apparatus.

11. The process of claim 7, wherein the cleaning includes circulating the flow of reacted synthesis gas through at least one cyclone and a scrubbing apparatus.

12. The process of claim 8, wherein cleaning at least the part of the second volume of gas includes collecting the second volume of gas directly from the solids reactor.

13. The process of claim 12, wherein collecting the second volume of gas directly from the solids reactor includes:
analyzing a chemical composition of the second volume of gas; and
based at least on the chemical composition, bypassing a steam reformation reactor, wherein the steam reformation reactor comprises a set of metal coils heated to a temperature equal to or above about the first temperature.

14. A system, comprising:
a pyrolysis chamber comprising a vessel coated in its interior with a refractory material, and a first metal drum that houses an amount of feedstock material at a first pressure in the range of about 25 psi to about 100 psi and rotates about an axis of substantial cylindrical symmetry of the first metal drum; and
a solids reactor operationally coupled to the pyrolysis chamber, the solids reactor receives an amount of feedstock by-product from the pyrolysis chamber and houses the amount of feedstock by-product in a second metal drum at a second pressure in the range of about 25 psi to about 100 psi.

15. The system of claim 14, further comprising:
a steam reformation reactor that collects (i) gas generated through gasification of at least one of the amount of feedstock material within the pyrolysis chamber or the amount of feedstock by-product within the solids reactor, and (ii) reacts the gas with superheated steam.

16. The system of claim 15, further comprising:
an accumulation vessel that receives the amount of feedstock material and pressurizes the amount of feedstock material to the first pressure;
an accumulation chamber that collects the amount of feedstock material at the first pressure and injects the amount of feedstock material into the pyrolysis chamber.

17. The system of claim 14, wherein the amount of feedstock material is housed at a first temperature in the range of about 1000° F. to about 1750° F., and the amount of feedstock by-product is housed at a second temperature of at most about 1750° F.

18. The system of claim 14, wherein the first metal drum that houses the amount of feedstock material for a time interval in the range of about 10 minutes to about 36 minutes.

19. The system of claim 14, wherein the second metal drum houses the amount of feedstock by-product for a time-interval in a range of about 3 minutes to about 20 minutes.

20. The system of claim 17, wherein the pyrolysis chamber includes at least one heating element that heats the first metal drum to the first temperature.

21. The system of claim 17, wherein the solids reactor includes at least one heating element that heats the second metal drum to the second temperature.

22. The system of claim 15, wherein the gas within the steam reformation reactor reacts with the superheated steam for a time interval shorter than about 10 seconds.

23. The system of claim 22, wherein reacted gas is ejected from the steam reformation reactor at a temperature of at least about 1000° F., the reacted gas is synthesis gas.

24. The system of claim 23, wherein the reacted gas is ejected to a cleaning platform where the reacted gas is cleaned of particulate matter, impurities, or a combination thereof, wherein the cleaning platform includes at least one of a cyclone or a scrubbing apparatus.

25. The system of claim 14, wherein the pyrolysis chamber includes a motor that rotates the first metal drum at a predetermined angular velocity.

26. The system of claim 14, wherein the solids reactor includes a motor that rotates the second metal drum at a predetermined angular velocity.

27. An apparatus, comprising:
means for gasifying the feedstock material in a plurality of gasification chambers at a first temperature and a first pressure in the range of about 25 psi to about 100 psi, and producing a first volume of gas and a first amount of by-product material; and
means for injecting at least a portion of the first amount of by-product material into one or more solids reactors functionally coupled to the plurality of gasification chambers

28. The apparatus of claim 27, further comprising:
means for gasifying at least the portion of the first amount of by-product material in the one or more solids reactors at a second temperature and a second pressure in the range of about 25 psi to about 100 psi, and producing a second volume of gas and a second amount of by-product material.

29. The apparatus of claim 27, wherein the means for gasifying the feedstock material in the gasification chamber at the first temperature includes means for heating a metal drum that resides within the gasification chamber to substantially the first temperature, where the first temperature is in the range of about 1000° F. to about 1750° F.

30. The apparatus of claim 27, wherein the means for gasifying at least the portion of the first amount of by-product material in the one or more solids reactors at the second temperature includes means for heating to substantially the second temperature at least one metal drum that resides within a respective solids reactor in the one or more solids reactors, the second temperature is at most about 1750° F.

31. The apparatus of claim 27, further comprising:
means for reacting with superheated steam at least one of the first volume of gas or the second volume of gas, wherein gas in the first volume of gas is pyrolysis gas and gas in the second volume of gas is substantially synthesis gas.

32. The apparatus of claim 30, further comprising:
means for cleaning one or more of the first volume of gas or the second volume of gas.
